(19) United States
(12) Patent Application Publication
(10) Pub. No.: US 2010/0054835 A1
(43) Pub. Date: Mar. 4, 2010

(54) MOVABLE MEMBER DRIVE CONTROL DEVICE AND METHOD AND PRINTING APPARATUS

(75) Inventor: Toru Hayashi, Suwa-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Shinjuku-ku (JP)

(21) Appl. No.: 12/550,312

(22) Filed: Aug. 28, 2009

(30) Foreign Application Priority Data
Aug. 29, 2008 (JP) 2008-221228

(51) Int. Cl. B41J 11/44

(52) U.S. Cl. 400/76

(57) ABSTRACT

Provided is a movable member drive control device including: a drive unit for driving a movable member; a position detection unit for detecting the position of the movable member; a drive control unit for controlling the driving of the drive unit in accordance with the position of the movable member, detected by the position detection unit; and a determination unit for determining whether or not vibration of the movable member is reduced by the drive control unit.

Priority is claimed under 35 U.S.C. § 119 to Japanese Application No. 2008-221228 filed on Aug. 29, 2008, which is hereby incorporated by reference in its entirety.

### BACKGROUND

1. Technical Field

The present invention relates to a movable member drive control device and method and a printing apparatus.

2. Related Art

In a printing apparatus that performs printing by driving a carriage in a direction perpendicular to the direction for transporting a printing medium, driving of the carriage is performed by motors. As such a carriage drive motor, a DC motor is typically used. Since such a DC motor has a gap between the magnetic poles of a stator thereof, the shaft of the DC motor is unable to rotate smoothly, and hence vibration called cogging is generated. Such vibration causes a periodic fluctuation in the moving speed of the carriage, and hence provides a part of the cause of irregularities in color in the reciprocating direction of the carriage. Such a periodic fluctuation in the moving speed of the carriage can be also caused due to an eccentricity of a motor pulley that transmits a driving force of a motor to the carriage, or a vibration of the motor pulley and even mechanical resonance. Although “cogging vibration” means a vibration caused by a DC motor in its strict sense, in the following descriptions, not only the vibration caused by the DC motor, but also the periodic fluctuation occurring in the moving speed of the carriage will be collectively referred to as “cogging vibration.”

As a technique for reducing the cogging vibration, JP-A-2006-095697 discloses a technique, called active damper, that supplies a driving electric power capable of generating a sinusoidal torque having the opposite phase to a cogging vibration to the motor to reduce the cogging vibration per se which is the vibration source, thereby reducing the carriage vibration.

However, when a change occurs in the cogging vibration due to aging or the like, it may become difficult to sufficiently suppress the carriage vibration. For this reason, it is necessary to make a determination as to whether or not the active damper is operating properly from time to time, and if the active damper is not operating properly, to redefine the optimum parameters of the active damper. The determination as to whether or not the active damper is operating properly is carried out by a special-purpose sequence which is prepared as a part of the initialization sequence during a power-on state. Therefore, the period of time required for completing the power-on sequence increases. Such a problem is not limited to printing apparatuses, but is a typical problem with apparatuses that drive a movable member.

### SUMMARY

An advantage of some aspects of the invention is that it provides a movable member drive control device and method and a printing apparatus capable of appropriately determining the operation of an active damper without needing to prepare a special-purpose sequence.

According to a first aspect of the invention, there is provided a movable member drive control device including: a drive unit for driving a movable member; a position detection unit for detecting the position of the movable member; a drive control unit for controlling the driving of the drive unit in accordance with the position of the movable member, detected by the position detection unit; and a determination unit for determining whether or not vibration of the movable member is reduced by the drive control unit.

In the above aspect of the present invention, the drive control unit may control the driving of the drive unit so that the vibration in a moving direction of the movable member is cancelled out. In this case, the movable member may be driven in a variable moving range by the drive unit, and the determination unit may use the range of movement of the movable member as a target range of the determination.

In the above aspect of the present invention, the drive control unit may stop the control when it is determined that the vibration of the movable member is not reduced by the determination unit. In this case, the drive control unit may stop the control with respect to at least the determination target range when the movable member is driven in a variable moving range.

In the above aspect of the present invention, the determination unit may make the determination whether or not the vibration of the movable member is reduced, based on an average oscillating quantity obtained when the movable member has been driven over several times. In this case, the determination unit may determine that the vibration of the movable member is reduced, provided that the average oscillating quantity does not exceed an absolute threshold which is allowable as the vibration of the movable member, and that the average oscillating quantity does not exceed an addition of a reference oscillating quantity and a predetermined relative threshold, the reference oscillating quantity being an oscillating quantity when it is determined that the vibration of the movable member is reduced by the control of the drive control unit. Further, when the average oscillating quantity is smaller than the reference oscillating quantity, the value of the reference oscillating quantity may be replaced with the value of the average oscillating quantity.

In the above aspect of the present invention, the drive unit may have a plurality of speed modes as the speed for driving the movable member, and the determination unit may perform the determination as to whether or not the vibration of the movable member is reduced for each of the plurality of speed modes.

In the above aspect of the present invention, the determination unit may perform the determination as to whether or not the vibration of the movable member is reduced, on the condition that the movable member has passed through each of a plurality of areas dividing the movable range of the movable member.

In the above aspect of the present invention, the drive control unit may have registered therein parameters for controlling the driving of the drive unit for each of a plurality of areas dividing the movable range of the movable member, and the determination unit may perform the determination as to whether or not the vibration of the movable member is reduced, for each of the plurality of areas, on the condition that the movable member has passed through the area.

In the above aspect of the present invention, the movable member drive control device may include a parameter memory having registered therein parameters used by the drive control unit for controlling the driving of the drive unit; and a parameter update unit for obtaining new parameters for cancelling the vibration of the movable member to update the contents of the parameter memory with the new parameters. In this case, the parameter update unit may be configured to: execute the updating at later possible timings, when it is determined that there is a risk of occurrence of failures in the driving of the movable member or a cause of occurrence of failures and the determination unit has determined that the vibration of the movable member is not reduced; and execute the updating after the number of drivings of the movable member by the drive unit has exceeded a predetermined number of times, when the determination unit has determined that the vibration of the movable member is not reduced, under a state where there is neither the risk of occurrence of failures in the driving of the movable member nor the cause of occurrence of failures.

When a plurality of speed modes is used, the parameter update unit may update the parameters in accordance with the speed mode. In this case, the parameters obtained for a speed mode which requires high quality may be applied to other speed modes. Moreover, when the parameters are registered for each of a plurality of areas dividing the movable range of the movable member, the parameter update unit may update the parameters for each area.

In the above aspect of the present invention, the movable member drive control device may include a parameter memory having registered therein parameters used by the drive control unit for controlling the driving of the drive unit; and a parameter update unit for obtaining new parameters for cancelling the vibration of the movable member to update the contents of the parameter memory with the new parameters. In this case, the parameter update unit may sequentially supply gradually different parameters to the drive control unit to measure oscillating quantities of the movable member with the different parameters, calculate an oscillating quantity obtained with a median parameter of the plurality of parameters as the average of the oscillating quantities measured with a plurality of parameters, and update the contents of the parameter memory with parameters which result in smaller oscillating quantities.

In the above aspect of the present invention, the movable member drive control device may include a parameter memory having registered therein parameters used by the drive control unit for controlling the driving of the drive unit; and a parameter update unit for obtaining new parameters for cancelling the vibration of the movable member to update the contents of the parameter memory with the new parameters. In this case, the parameter update unit may supply gradually different parameters individually to the drive control unit to measure oscillating quantities of the movable member with the different parameters, and update the contents of the parameter memory with parameters which result in smaller gains than the parameters having the smallest oscillating quantity.

In the above aspect of the present invention, the movable member drive control device may include a parameter memory having registered therein parameters used by the drive control unit for controlling the driving of the drive unit; and a parameter update unit for supplying gradually different parameters individually to the drive control unit to measure oscillating quantities of the movable member with the different parameters, thereby obtaining optimum parameters for cancelling the vibration of the movable member to update the contents of the parameter memory with the optimum parameters. In this case, for each of the gradually different parameters, a gain capable of cancelling an oscillating quantity associated with the characteristics of the drive unit is set as the upper limit of a gain for cancelling the vibration of the movable member.

In the above aspect of the present invention, the movable member may be a carriage mounting thereon a print head of a printing apparatus, and the determination unit may determine whether or not the vibration of the carriage is reduced in a state where printing is performed by the print head.

According to a second aspect of the invention, there is provided a movable member drive control method including: a first step of measuring a vibration occurring in a movable member; a second step of, when the movable member is driven, controlling the driving of the movable member in accordance with the position of the movable member based on the measurement results in the first step so that the vibration is cancelled out, in which a determination is made as to whether or not the vibration of the movable member is reduced by the control during execution of the second step.

According to a third aspect of the invention, there is provided a printing apparatus including: a motor that drives a carriage mounting thereon a print head; a position detection unit for detecting the position of the carriage; a drive control unit for controlling the driving of the motor in accordance with the position of the carriage, detected by the position detection unit; and a determination unit for determining whether or not the vibration of the carriage is reduced by the drive control unit, in which the determination unit makes the determination as to whether or not the vibration of the carriage is reduced, in a state where printing is performed by the print head.

According to a fourth aspect of the invention, there is provided a printing apparatus including: a motor that drives a carriage mounting thereon a print head; a position detection unit for detecting the position of the carriage; a control portion that controls movement of the carriage, in which the control portion controls the driving of the motor in accordance with the position of the carriage, detected by the position detection unit to perform an active damping control that cancels the vibration of the carriage, and determines whether or not the vibration of the carriage is reduced by the active damping control, in a state where printing is performed by the print head.

### BRIEF DESCRIPTION OF THE DRAWINGS

The invention will be described with reference to the accompanying drawings, wherein like numbers reference like elements.

FIG. 1 is a schematic view illustrating the configuration of a printing apparatus according to an embodiment of the invention, illustrating a simplified structure of a mechanical system of the printing apparatus and a block configuration of a control system controlling the mechanical system.

FIG. 2 is a schematic view, taken from a different direction from FIG. 1, illustrating the structure of a carriage of the printing apparatus illustrated in FIG. 1 and the periphery thereof.

FIG. 3 is a block diagram illustrating an example of a carriage drive circuit of the printing apparatus illustrated in FIG. 1.

FIG. 4 is a view for describing a damping operation of an active damper used in the printing apparatus illustrated in FIG. 1.

FIG. 5 is a flowchart of an oscillation reduction effect determination process in the printing apparatus illustrated in FIG. 1.

FIG. 6 is a schematic view for describing the relationship between a speed oscillating quantity, an absolute threshold, a relative threshold, and a reference oscillating quantity used in the determination process illustrated in FIG. 5.

FIG. 7 is a schematic view illustrating a configuration example of a calibration flag used in the printing apparatus illustrated in FIG. 1.

FIG. 8 is a schematic view for describing a method of determining the necessity for calibration when the carriage in the printing apparatus illustrated in FIG. 1 is driven in a variable moving range.

FIG. 9 is a flowchart of a calibration execution determination process by a calibration execution control circuit in the carriage drive circuit illustrated in FIG. 3.

FIG. 10 is a flowchart of a calibration execution process by the calibration execution control circuit in the carriage drive circuit illustrated in FIG. 3.

FIG. 11 is a schematic view for describing an example of a damper waveform of the active damper used in the printing apparatus illustrated in FIG. 1, illustrating an example of the optimum phase for each of a plurality of areas dividing the carriage movable range.

FIG. 12 is a flowchart of an optimum parameter detection process in the calibration execution control process illustrated in FIG. 10.

FIG. 13 is a flowchart illustrating the details of an optimum phase detection process in the optimum parameter detection process illustrated in FIG. 12.

FIG. 14 is a schematic view for describing a smoothing process for detecting the optimum phase performed by the printing apparatus illustrated in FIG. 1, illustrating the storage locations, on a memory, of measured average oscillating spectrums.

FIG. 15 is a graph for comparison between the speed oscillating quantity before averaging used in the printing apparatus illustrated in FIG. 1 and the speed oscillating quantity obtained after averaging three values.

FIG. 16 is a flowchart illustrating the details of an optimum gain detection process in the optimum parameter detection process illustrated in FIG. 12.

FIG. 17 is a schematic view for describing a smoothing process for detecting the optimum gain performed by the printing apparatus illustrated in FIG. 1, illustrating the storage locations, on a memory, of measured average oscillating spectrums.

FIG. 18 is a graph illustrating an example of the relationship between the initial oscillating spectrum after calibration in the printing apparatus illustrated in FIG. 1 and the oscillating spectrum after lapse of a predetermined period of time.

FIG. 19 is a flowchart illustrating the details of an oscillation reduction effect detection process in the calibration execution control process illustrated in FIG. 10.

FIG. 20 is a flowchart of a carriage driving process for verification of the effect of the calibration in the oscillation reduction effect detection process illustrated in FIG. 19.

### DESCRIPTION OF EXEMPLARY EMBODIMENTS

Exemplary embodiments will be described herein below with reference to the accompanying drawings.

### Configuration

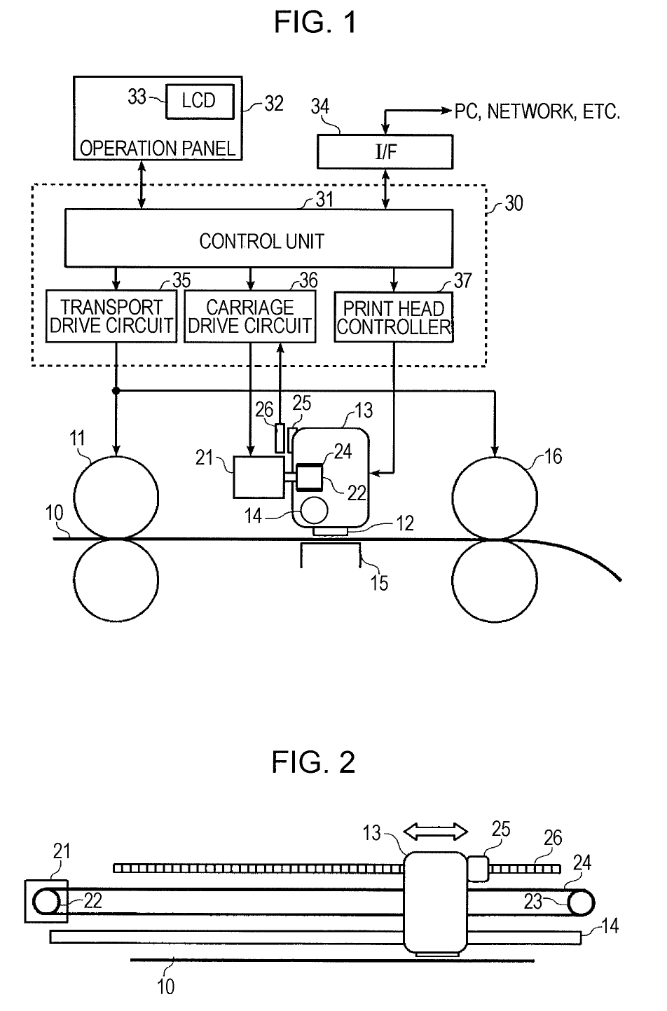

FIG. 1 is a schematic view illustrating the configuration of a printing apparatus according to an embodiment of the invention, illustrating a simplified structure of a mechanical system of the printing apparatus and a block configuration of a control system controlling the mechanical system. The mechanical system of the printing apparatus includes a transport roller 11 that transports a printing medium 10, a print head 12, a carriage 13 as a movable member that mounts thereon the print head 12, a guide 14 that guides movement of the carriage 13, a platen 15 that is disposed to oppose the print head 12 with the printing medium 10 disposed therebetween, and a discharge roller 16 that discharges the printing medium 10. The mechanical system further includes a DC motor 21, a drive pulley 22, and an endless belt 24, as a drive unit that drives the carriage 13, and a linear encoder 25 and a linear scaler 26 as a position detection unit that detects the position of the carriage 13.

Moreover, the control system of the printing apparatus includes a main control unit 31 that is a part of a control unit 30 and controls the overall operation of the printing apparatus, an operation panel 32 that allows users to perform operations thereon, a liquid crystal display portion (LCD) 33 that is provided to the operation panel 32 and performs various display operations, an interface 34 for connection to external devices, a transport driving circuit 35 that controls the driving of the transport roller 11 and the discharge roller 16, a carriage drive circuit 36 that controls the driving of the DC motor 21 to drive the carriage 13, and a print head controller 37 that controls printing of the print head 12. The transport driving circuit 35, the carriage drive circuit 36, and the print head controller 37 are configured as a part of the control unit 30.

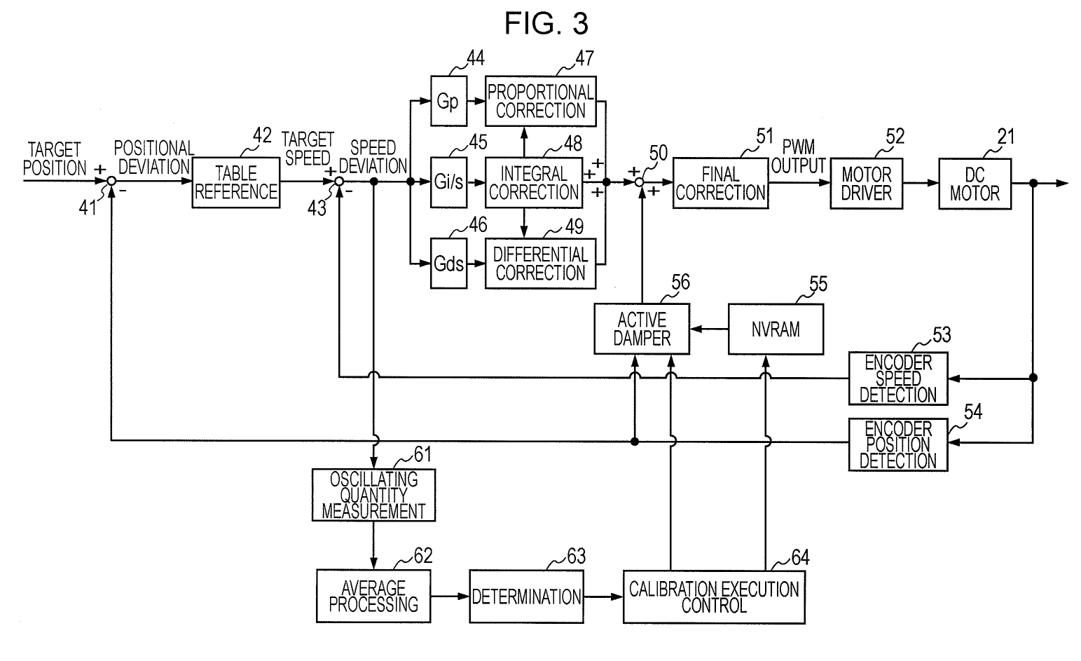

FIG. 2 is a schematic view, taken from a different direction, illustrating the structure of the carriage 13 and the periphery thereof. The carriage 13 is attached to the endless belt 24, which is stretched between the drive pulley 22 and a driven pulley 23. When the drive pulley 22 is driven by the DC motor 21, the carriage 13 reciprocates along the guide 14 between the drive pulley 22 and the driven pulley 23. The linear encoder 25 is provided to the carriage 13, and the position of the carriage 13 is detected by the linear scaler 26 which is disposed in parallel to the endless belt 24. The detected values are fed back to the carriage drive circuit 36.

FIG. 3 is a block diagram illustrating an example of the carriage drive circuit 36 illustrated in FIG. 1. In this example, a configuration where the DC motor 21 is subjected to a PID control is illustrated. For drive control of the DC motor 21, the carriage drive circuit 16 includes a subtractor 41, a table reference circuit 42, a subtractor 43, a proportional coefficient circuit 44, an integral coefficient circuit 45, a differential coefficient circuit 46, a proportional correction circuit 47, an integral correction circuit 48, a differential correction circuit 49, an adder 50, a final correction circuit 51, a motor driver 52, an encoder speed detection circuit 53, and an encoder position detection circuit 54. The carriage drive circuit 36 further includes a NVRAM (Nonvolatile RAM; Nonvolatile Random Access Memory) 55 as a parameter memory having registered therein parameters for controlling the driving of the carriage 13, and an active damper 56 as a drive control unit that controls the driving of the DC motor 21 in accordance with the position of the carriage 13, detected by the linear encoder 25. Moreover, the carriage drive circuit 36 includes an oscillating quantity measurement circuit 61, an average processing circuit 62, and a determination circuit 63, as a determination unit that determines whether or not the vibration of the carriage 13 is reduced by the active damper 56. Furthermore, the carriage drive circuit 36 includes a calibration execution control circuit 64 as a parameter update unit that controls the operation of the active damper 56 and obtains new parameters for cancelling the vibration of the carriage 13, thereby updating the contents of the NVRAM 55.

### Driving Control of DC Motor

The driving control of the DC motor 21 by the carriage drive circuit 36 will be described with reference to FIG. 3. The carriage drive circuit 36 is supplied with a target carriage position from the control unit 31.

The subtractor 41 subtracts the actual position detected by the encoder position detection circuit 54 from the input target position to calculate a positional deviation. The table reference circuit 42 has registered therein a target speed which corresponds to the positional deviation and outputs a target speed corresponding to the positional deviation calculated by the subtractor 41. The subtractor 43 subtracts the actual speed detected by the encoder speed detection circuit 53 from the target speed to calculate a speed deviation.

The proportional coefficient circuit 44, the integral coefficient circuit 45, and the differential coefficient circuit 46 multiply the speed deviation calculated by the subtractor 43 by a proportional coefficient, an integral coefficient, and a differential coefficient, respectively. The proportional correction circuit 47, the integral correction circuit 48, and the differential correction circuit 49 perform necessary corrections on the respective outputs of the proportional coefficient circuit 44, the integral coefficient circuit 45, and the differential coefficient circuit 46.

The final correction circuit 51 performs final corrections to the addition of the output value of the active damper 56 and the sum of outputs of the proportional correction circuit 47, the integral correction circuit 48, and the differential correction circuit 49 and then supplies the corrected value to the motor driver 52 as a pulse-width-modulated (PWM) motor drive signal. The motor driver 52 drives the DC motor 21 in accordance with the motor drive signal. The position of the carriage 13 having moved with the driving of the DC motor 21 is read by the linear encoder 25, and the speed information and the positional information of the carriage 13 are output by the encoder speed detection circuit 53 and the encoder position detection circuit 54, respectively. The above is the description of a typical PID control, and the further detailed description thereof will be omitted in this disclosure.

### Basic Operation of Active Damper

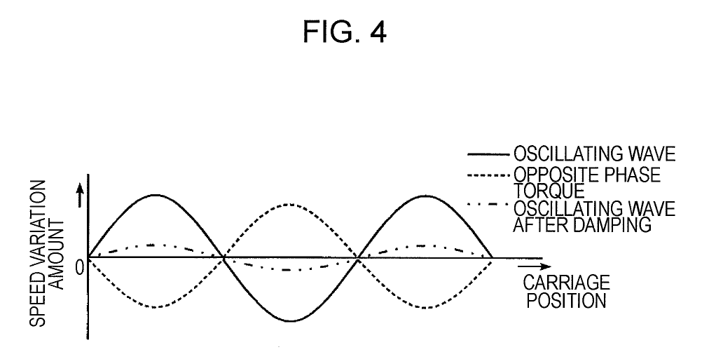

FIG. 4 is a view for describing a damping operation of the active damper 56, and the description of the NVRAM 55 and the operation of the active damper 56 will be provided with reference to FIG. 4.

In the event of cogging vibration, the speed of the carriage 13 fluctuates periodically (such fluctuation will be referred to as “speed oscillation”) as depicted by the solid line in FIG. 4, causing a periodic lead or lag in the moving direction of the carriage 13. To reduce the speed oscillation, the torque of the DC motor 21 is controlled so that a sinusoidal wave as depicted by the dotted line in FIG. 4 is added to the movement of the carriage 13, namely so that a vibration having the opposite phase to the cogging vibration is generated. That is to say, the active damper 56 generates a signal having the opposite phase to the cogging vibration, and the adder 50 adds the signal to the final output value obtained after PID calculation, namely, the sum of the respective outputs of the proportional correction circuit 47, the integral correction circuit 48, and the differential correction circuit 47. As a result, the speed oscillation of the carriage 13 can be suppressed greatly as depicted by the two-dot chain line in FIG. 4.

The active damper 56 has stored therein a table of values of the sinusoidal wave (damper wave) having the same cycle as the cogging vibration as a table, and is configured to obtain a waveform value having a phase corresponding to the position of the carriage 13, detected by the encoder position detection circuit 54, for each cycle of PID calculation and output the obtained waveform value which is multiplied by a damper gain (amplitude). The optimum phase offset (a difference in the phase of the damper waveform relative to the position of the carriage 13) and the optimum damper gain for reducing the vibration of the carriage 13 are calculated in advance for each of an outward path and a homeward path by calibration during manufacture, shipment, or repairment of the printing apparatus and are registered in the NVRAM 55.

As the table of damper waveform values, a ring buffer table is used in which a sinusoidal wave of one cycle is defined by an array of 256 entries, for example. The entry number in the table is calculated from the lower 8-bit values of the encoder position information and the phase offset, and the waveform value of the phase corresponding to the position of the carriage 13 can be obtained by reading the corresponding value of the entry number. The damper waveform values may not be stored in the active damper 56 but may be stored in the NVRAM 55 or in other memories.

### Determination on Oscillation Reduction Effect

Next, the determination on the oscillation reduction effect by the oscillating quantity measurement circuit 61, the average processing circuit 62, and the determination circuit 63 will be described.

The oscillating quantity measurement circuit 61 performs Fourier expansion on the speed deviation output by the adder 43 for each cycle of PID calculation in a state where printing is actually performed by the print head 12, thereby calculating an oscillating spectrum which is a speed oscillating quantity. Since the vibration of interest is the cogging vibration, the Fourier expansion may use only one frequency. When the driving of the carriage 13 is interrupted halfway of its reciprocating movement (referred to as “pass”) because of an event that the cover of the printing apparatus is open, the oscillating spectrum of this pass will not be subjected to the determination for optimization.

In order to eliminate the influence of noise during printing, the average processing circuit 62 averages the speed oscillating quantities measured by the oscillating quantity measurement circuit 61 to calculate an average oscillating quantity of the carriage 13 after driven for several times, e.g., for 400 passes. Here, it is not necessary to store all measurement values in order to calculate the average value. The average value up to the [N+1]-th pass can be calculated by adding a multiplication of the average value up to the N-th pass by N/[N+1] and a multiplication of the measured value for the [N+1]-th pass by 1/[N+1], Therefore, by repeating such a calculation, the average oscillating quantity can be obtained with a small memory capacity. The determination circuit 63 determines whether or not oscillation reduction effect can be obtained with the average oscillating quantity calculated by the average processing circuit 62, namely whether or not the parameters registered in the NVRAM 55 are optimum.

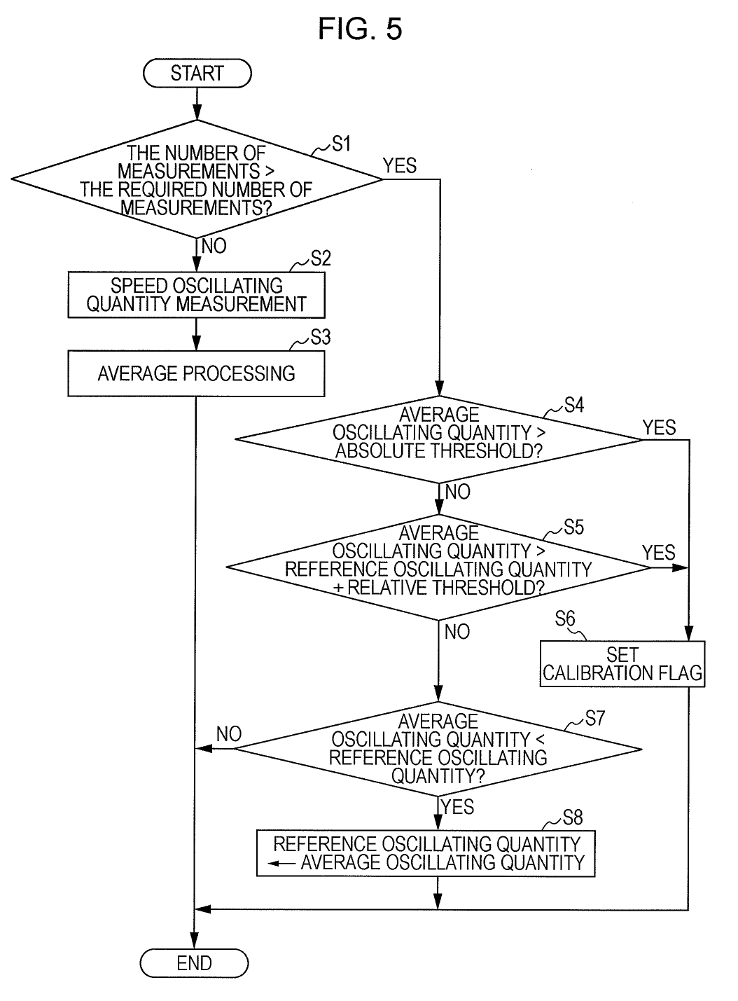

FIG. 5 is a flowchart of an oscillation reduction effect determination process, and

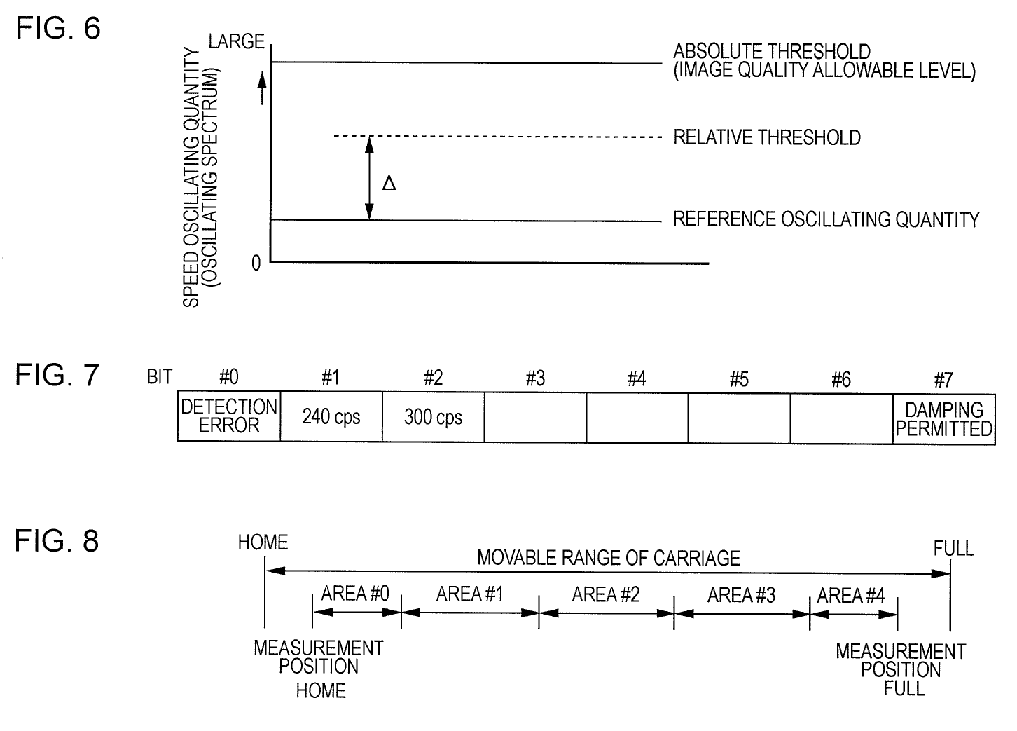

FIG. 6 is a schematic view for describing the relationship between a speed oscillating quantity, an absolute threshold, a relative threshold, and a reference oscillating quantity used in the determination process. With reference to FIGS. 5 and 6, the operation of the oscillating quantity measurement circuit 61, the average processing circuit 62, and the determination circuit 63 will be described in more detail.

If the number of measurements does not exceed a predetermined required number of measurements, e.g., 400 passes (N in step S1), then, the speed oscillating quantity during printing is measured for each pass of the carriage 13 by the oscillating quantity measurement circuit 61 (step S2), and an averaging process is subsequently executed by the average processing circuit 62 (step S3). If the number of measurements exceeds the required number of measurements (Y in step S1), then, the determination circuit 63 makes a determination as to whether or not the average oscillating quantity calculated by the average processing circuit 62 is larger than an absolute threshold or than the sum of a reference oscillating quantity and a relative threshold.

The absolute threshold is a value which is set as a level in which the quality of printed images is allowable. The reference oscillating quantity is a speed oscillating quantity obtained when it is determined that the vibration of the carriage 13 is reduced by the control of the active damper 56, namely when the carriage 13 is driven with the optimum parameter after calibration. The relative threshold is a value range relative to the reference oscillating quantity, in which it can be determined that the control of the active damper 56 is effective to some extent. Specifically, when the absolute threshold is 230 (in arbitrary unit), for example, the relative threshold Δ is +100.

If the average oscillating quantity of the speed oscillating quantities is larger than the absolute threshold (Y in step S4), or is larger than the sum of the reference oscillating quantity not larger than the absolute threshold and the relative threshold (Y in step S5), then, the determination circuit 63 sets a calibration flag by determining that there is no oscillation reduction effect by the active damper 56 and a calibration is required (step S6). If the average oscillating quantity of the speed oscillating quantities is not larger than the absolute threshold (N in step S4) and is not larger than the sum of the reference oscillating quantity and the relative threshold (N in step S5), then, the determination circuit 63 makes a determination as to whether the average oscillating quantity is smaller than the reference oscillating quantity (step S7). If smaller (Y in step S7), then, the reference oscillating quantity is replaced with the average oscillating quantity (step S8). If not smaller (N in step S7), then, the flow ends.

By repeating the measurement for the required number of measurements, it is possible to eliminate the influence of noise associated with printing and to thus correctly determine the vibration reduction effect. The number of measurements is reset when power is input again or calibration is performed after the number reciprocations of the carriage 13 has reached the required number of measurements, namely, 400 passes, for example.

Although in this example, the measurement of the speed oscillating quantity was performed for consecutive passes up to the required number of measurements, the speed oscillating quantity may be measured for every several passes rather than for consecutive passes. When the number of measurements has reached the required number of measurements, subsequent measurement may be performed continuously or after a predetermined delay.

When the calibration flag is set, the parameters registered in the NVRAM 55 are not in an optimized state and maintain the state until calibration is performed. The active damper 56 stops the control based on the parameters registered in the NVRAM 55 for the next pass with respect to at least the range which is subject to the determination. This is because otherwise, it is highly likely that the speed oscillating quantity may be adversely increased by the control of the active damper 56.

### Determination of Necessity for Calibration

FIG. 7 is a schematic view illustrating a configuration example of the calibration flag. In this example, the calibration flag is configured by one byte. Bit #0 represents detection errors of optimum parameters: “0” indicates no errors and “1” indicates errors. This bit is set to “1” when errors are found as a result of the determination on the oscillation reduction effect and is cleared to “0” when no errors are found. Bit #1 and Bit #2 represent calibration requests for different speed modes, respectively, and these bits are set when the parameters of the active damper 56 during driving thereof are determined to be not optimum and are cleared by calibration. In this example, 240 cps (characters per second) and 300 cps are illustrated as examples of different speed modes. Bit #7 represents permittability of active damping, and this bit is cleared when error determination conditions are satisfied during initialization of the NVRAM 55 and is set unless errors are found as a result of the determination on the oscillation reduction effect. When this bit is set to “0”, a normal calibration is inhibited and the output of the active damper is regarded as invalid.

Here, the normal calibration is a calibration which is performed during maintenance of the printing apparatus, and is performed in a printing preparatory processing sequence.

As will be understood from FIG. 7, in this example, a plurality of speed modes is used as the speed at which the DC motor 21 drives the carriage 13. In such a case, the determination as to whether or not the vibration of the carriage 13 is reduced is made for each of the plurality of speed modes. The speed mode is not limited the two modes, 240 cps and 300 cps, but may be other speed values, and three or more speed modes may be used.

### Division of Movable Range

FIG. 8 is a schematic view for describing a method of determining the necessity for calibration when the carriage 13 illustrated in FIG. 1 is driven in a variable moving range. When an image is actually printed by the print head 12, the moving range of the carriage 13 is set to be variable in accordance with the width of the image to be printed. For this reason, the determination on the oscillation reduction effect needs to be performed for the actual moving range of the carriage 13. Therefore, the movable range of the carriage 13 is divided into a plurality of areas, and the determination as to whether or not the vibration of the carriage 13 is reduced is made for each of the divided areas, on condition that the carriage 13 has passed through the area.

In the example illustrated in FIG. 8, the movable range which extends from the home position, which is the initial position of the carriage 13, to the full position which is the termination position is divided into five areas: Area #0 to Area #4. A portion of Area #0 near the home position is an area where the carriage 13 is accelerated in the outward path and decelerated in the homeward path, and which is not subject to the measurement of the speed oscillating quantity. A portion of Area #4 near the full position is an area where the carriage 13 is decelerated in the outward path and accelerated in the homeward path, and which is not subject to the measurement of the speed oscillating quantity. For example, when the printing range ranges up to the halfway of Area #3, the measurement of the speed oscillating quantity by the oscillating quantity measurement circuit 61 is performed for each of the areas Area #0 to Area #2. The average processing circuit 62 calculates the average for each area, and the determination circuit 63 performs the determination for each area.

In the NVRAM 55, parameters are registered for each of the plurality of areas dividing the movable range of the carriage 13. The active damper 56 reads from the NVRAM 55, parameters corresponding to an area to which the position detected by the encoder position detection circuit 54 belongs and uses the parameters for controlling the driving state of the DC motor 21. In such a case, it is preferable that the boundary of areas for the determination of the oscillation reduction effect is identical to the boundary of areas where parameters are switched, and more preferably, both areas are identical to each other. By doing so, it is possible to determine the oscillation reduction effect for each of the areas on which parameters are set. When parameters are not divided for each area, only the determination on the oscillation reduction effect may be performed for each area.

### Calibration Mode

The calibration execution control circuit 64 illustrated in FIG. 3 obtains new parameters for cancelling the vibration of the carriage 13, if necessary, and executes calibration for updating the contents of the NVRAM 55. Specifically, the carriage 13 is scanned for a plurality of passes as a separate operation of printing operations, thereby detecting the optimum values of a damper gain (amplitude) and a phase offset and registering them in the NVRAM 55.

The calibration can be classified into a forced calibration and a normal calibration. The forced calibration is executed when a forced calibration is determined to be required as a result of self-diagnosis by operation from the operation panel 32 or is executed by command processing during manufacturing steps before shipment or on the field or at a factory by a service engineer. The normal calibration is executed in a subsequent printing preparatory sequence when oscillating spectrums are detected during printing and it is determined from the detected oscillating spectrums that the damper gain or the phase offset registered in advance in the NVRAM 55 is not optimum, namely when the calibration flag is set. Specifically, the speed mode for execution of the calibration is determined as follows. The speed mode is designated by the parameter of a command when the calibration is a forced calibration executed by commands; operations on a control panel when the calibration is a forced calibration executed by self-diagnosis; and the state of a calibration flag when the calibration is a normal calibration.

TABLE 1

| | Execution Timing | Mode Of Calibration Executed |
|---|---|---|
| Forced | Specific commands | Depends on the parameter of |
| calibration | | specific commands |
| | Self-Diagnosis | Depends On Panel Operations |
| Normal | Printing preparatory | Mode of calibration executed is |
| calibration | processing | determined by the |
| | | state of calibration flag |

### Calibration Execution Determination

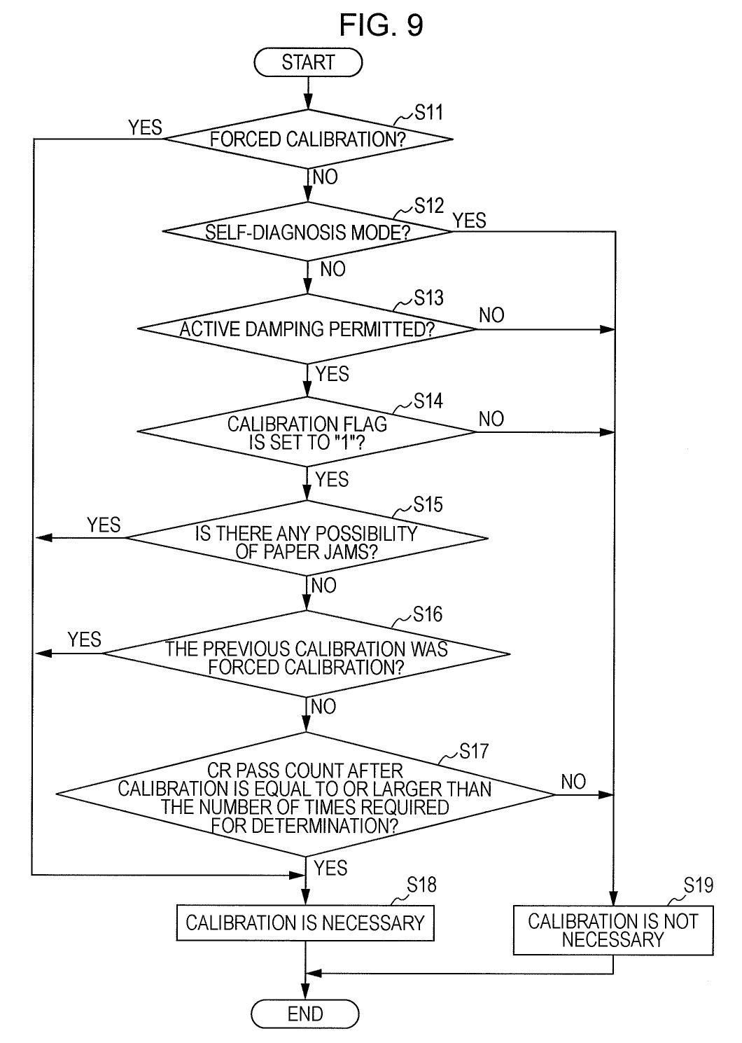

FIG. 9 is a flowchart of a calibration execution determination process by the calibration execution control circuit 64. The calibration execution control circuit 64 determines the necessity of a calibration in the printing preparatory processing sequence.

First, if a forced calibration is not designated (N in step S11) and a self-diagnosis mode other than the forced calibration is not designated by a panel operation (N in step S12), then, a calibration flag is referenced. If Bit #7 of the calibration flag is set to “1” (Y in step S13) and at least one of Bits #1 and #2 is set to “1” (Y in step S14), then, a determination is made as to whether or not there is any risk of paper jams in the printing apparatus after the previous calibration (step S15). If there is no risk (N in step S15), then, a determination is made as to whether or not the previous calibration is a forced calibration (step S16). If the previous calibration is not a forced calibration (N in step S16), then, a determination is made as to whether or not the pass count of the carriage 13 after the previous calibration was performed is equal to or larger than the number of times required for determination (step S17). When the pass count is equal to or larger than the number of times required for determination, it is determined that a calibration is necessary (step S18).

The calibration execution control circuit 64 determines that a forced calibration is necessary if the forced calibration is designated in step S11 (step S18). If the self-diagnosis mode is designated in step S12 (Y in step S12), it is determined that no calibration is necessary (step S19). If Bit #7 of the calibration flag is set to “0” in step S13 (N in step S13) and both of Bits #1 and #2 of the calibration flag is set to “0” in step S14 (N in step S14), it is determined that no calibration is necessary (step S19). If it is determined in step S15 that there is a risk of paper jams (Y in step S15) and it is determined in step S16 that the previous calibration is a forced calibration (Y in step S16), it is determined that a calibration is necessary (step S18). If the pass count for calibration after the previous calibration is smaller than the number of times required for determination (N in step S17), it is determined that no calibration is necessary (step S19).

In step S15, as the cause of the “risk of paper jams”, not only a case where paper jams are actually detected after the previous calibration was performed, but also a case where a fatal error such as overload, overcurrent, or large speed deviation occurs in the printing apparatus may be considered. This is because such a fatal error is highly likely to be caused by paper jams. When a paper jam occurs, there is a risk that mechanical conditions are varied such as a “tooth skip” occurs between the drive pulley 22 and the endless belt 24 illustrated in FIG. 3. In such a case, the parameters of the active damper 56, registered in the NVRAM 55 may deviate from the optimum values. Therefore, if the calibration flag is set to “1”, namely either one or both of Bits #1 and #2 is set to “1” in such a state, it is determined that a calibration is necessary.

Overspeed is another example of a fatal error of the printing apparatus. The overspeed is not associated with paper jams and it is thus considered that the parameters of the active damper 56 are unlikely to deviate from the optimum values. However, if only the occurrence of fatal errors is recorded but the types of the errors are not recorded, it may be determined that there is a risk of paper jams based on only the records of fatal errors.

Moreover, when the previous calibration is determined to be a forced calibration in step S16, there is a risk that the calibration was performed during manufacturing steps or at a factory by being retrieved from the running place and even a risk of transportation after calibrations. In such a case, the adjustments made during calibrations may become disordered because of transportation, and hence, when the calibration flag is set to “1” in such a state, it is determined that a calibration is necessary.

That is to say, when it is determined that there is a risk of occurrence of failures in the driving of the carriage 13 or a cause of occurrence of failures and that the vibration of the carriage 13 is not reduced, the calibration is performed at later possible timings to execute the updating of the parameters registered in the NVRAM 55. Moreover, when it is determined that the vibration of the carriage 13 is not reduced, under a state where there is neither the risk of occurrence of failures in the driving of the carriage 13 nor the cause of occurrence of failures, the calibration is performed when the number of drivings of the carriage 13 exceeds a predetermined number of times, thereby executing the updating of parameters registered in the NVRAM 55.

The reason for determining the pass count of the carriage 13 in step S17 is because the actual risk of image quality deterioration is small even the parameters are not determined to be optimum. Therefore, too frequent calibrations are considered troublesome for users. The number of times required for determination may be several tens of thousand passes, for example, fifty thousand passes.

### Calibration for Each Speed Mode

In the printing apparatus a plurality of speed modes is used as the speed for driving the carriage 13. For example, two speed modes are used: one is 240 cps for high quality and the other is 300 cps for high speed. In such a case, it is preferable to perform calibrations separately for the respective speed modes. However, when the calibrations are performed separately, it may be possible to obtain higher accuracy for optimum parameter detection; however, a considerable amount of time may be required. Therefore, when a calibration is performed for a plurality of speed modes by a normal calibration, the calibration may be performed in a Hybrid mode of calibration where the optimum parameters obtained for one speed mode can be applied to the other speed mode.

That is to say, as a mode of calibration, in addition to 240 cps and 300 cps modes where the calibration is performed for only one speed mode and an ALL mode where the calibration is performed for both speed modes, a Hybrid mode is prepared where the optimum parameters obtained for one speed mode are applied to the other speed mode. In the 240 cps and 300 cps modes of calibration, the carriage 13 is driven in the corresponding speed mode to detect the optimum parameters, and the parameter settings of the corresponding speed mode, registered in the NVRAM 55 are updated. In the ALL mode of calibration, the carriage 13 is driven in the respective speed modes of 240 cps and 300 cps to detect the respective optimum parameters, and the parameter settings of the respective speed modes, registered in the NVRAM 55 are updated.

Since a considerable amount of time is required in the ALL mode of calibration where calibrations are performed all the speed modes when it is necessary to perform calibrations in a plurality of speed modes, in the Hybrid mode of calibration, the parameters obtained for a speed mode which requires high quality are applied to other speed modes. That is to say, if the speed modes are 240 cps and 300 cps, the optimum parameters obtained for the 240 cps speed mode for high quality are registered in the NVRAM 55 as the parameters of both speed modes of 240 cps and 300 cps. In the case of the Hybrid mode of calibration, the determination on the oscillation reduction effect in the 300 cps speed mode is performed, and if there is no effect, the gain is set to zero. The modes of calibration are summarized in Table 2.

TABLE 2

| | Execution items | | |
|---|---|---|---|
| | Detection | Determination | |
| Calibration | Of Optimum | on oscillation | Updated NVRAM |
| mode | Parameter | reduction effect | area |
| 240 cps | Driven at 240 cps | Driven at 240 cps | Area of 240 cps |
| 300 cps | Driven at 300 cps | Driven at 300 cps | Area of 300 cps |
| ALL | Driven at 240 cps | Driven at 240 cps | Areas of 240 cps |
| | and 300 cps | and 300 cps | and 300 cps |
| Hybrid | Driven At 240 | Driven at 240 cps | Areas of 240 cps |
| | | and 300 cps | and 300 cps |

The ALL mode of calibration is executed during forced calibrations. On the other hand, the 240 cps and 300 cps modes of calibration is executed during normal calibrations when the respective bits of the calibration flag corresponding to respective speed modes are set. The Hybrid mode of calibration is executed during normal calibrations when the respective bits of the calibration flag corresponding to both of the speed modes of 240 cps and 300 cps are set. In the case of normal calibrations, even when the previously executed calibration was a forced calibration, the Hybrid mode of calibration is executed regardless of the states of a calibration flag. The execution of the Hybrid mode of calibration may be designated by operations on a control panel or a command.

### Calibration Execution Process

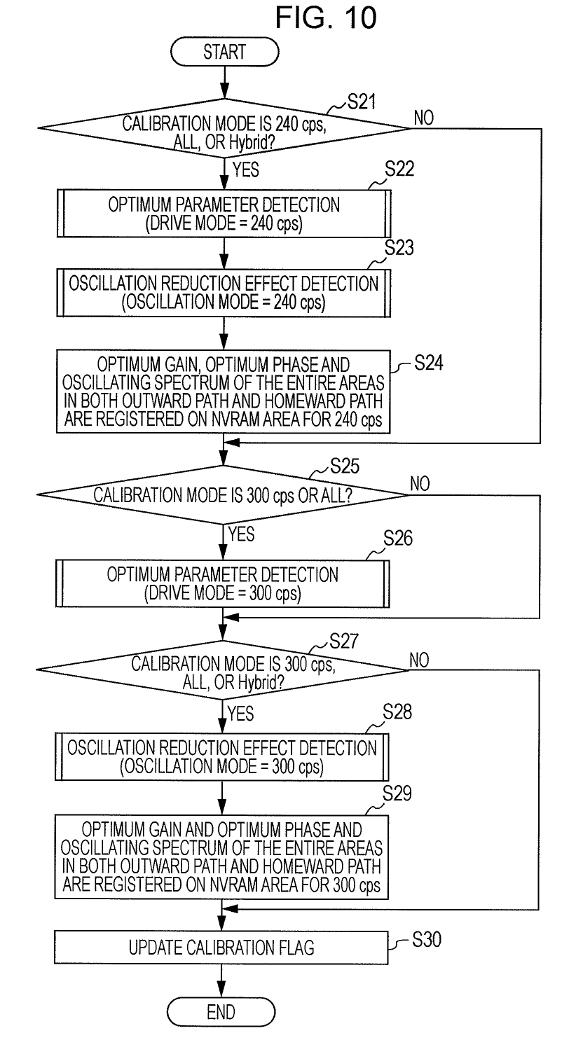

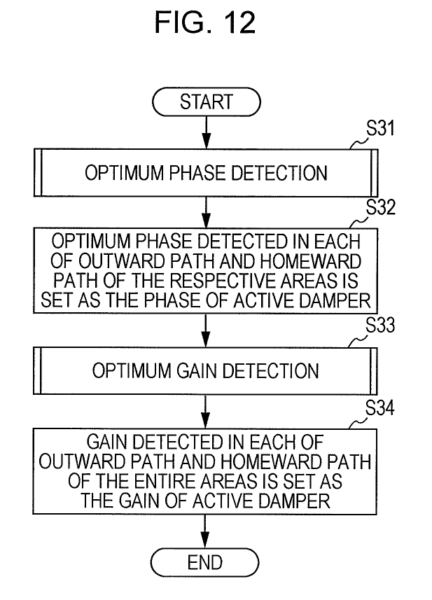

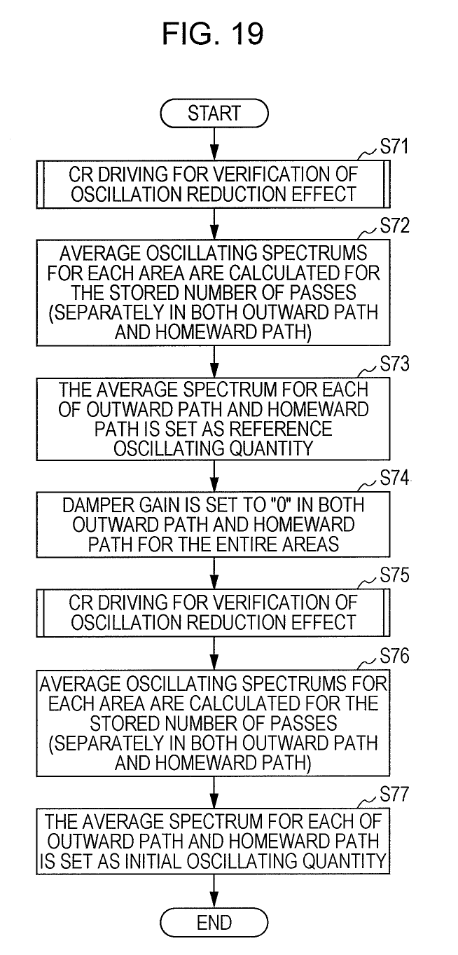

FIG. 10 is a flowchart of a calibration execution process by the calibration execution control circuit 64. When the calibration mode is 240 cps, ALL, or Hybrid (Y in step S21), an optimum parameter detection process (step S22; see FIG. 12 for detail) is executed with a speed mode of 240 cps. Subsequently, an oscillation reduction effect detection process (step S23; see FIG. 19 for detail) is executed with a speed mode of 240 cps. The optimum gain, the optimum phase, and the oscillating spectrum of the entire areas in both the outward path and the homeward path are registered in a 240 cps area in the NVRAM 55 (step S24).

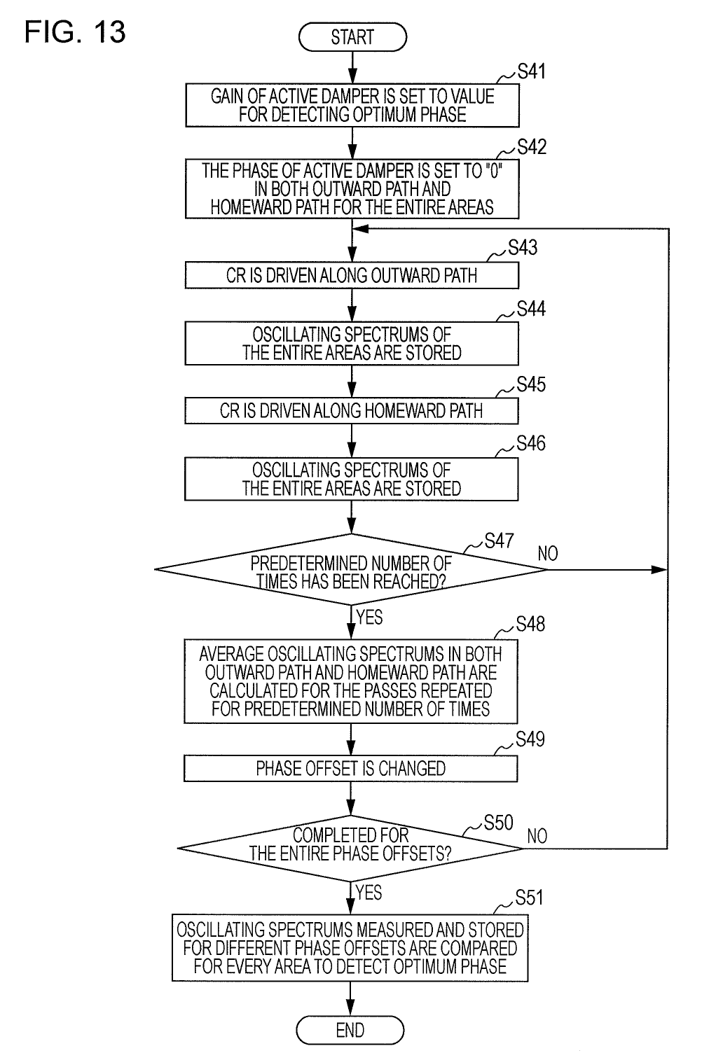

If the calibration mode is 300 cps (N in step S21 and Y in step S25) or ALL (Y in step S21 and Y in step S25), an optimum parameter detection process (step S26; see FIG. 10) is executed with a speed mode of 300 cps. Subsequently, if the calibration mode is 300 cps or ALL (Y in step S25 and Y in step S27) or Hybrid (N in step S25 and Y in step S27), an oscillation reduction effect detection process (step S28; see FIG. 13) is executed with a speed mode of 300 cps. That is to say, in the case of the Hybrid mode, the oscillation reduction effect in a drive mode of 240 cps is detected based on the parameters detected for the drive mode, and the oscillation reduction effect in a drive mode of 300 cps is detected based on the same parameters.

Subsequently, the optimum gain, the optimum phase, and the oscillating spectrum of the entire areas in both the outward path and the homeward path are registered in a 300 cps area in the NVRAM 55 (step S29). If the determination result in step S27 is N, the calibration flag is updated subsequently to the operation of step S29 (step S30), whereby the calibration execution process is completed.

Although the above description has been made for the case where two speed modes of 240 cps and 300 cps are used as the speed mode of the carriage 13, the speed values are not limited to these values and more number of speed modes may be used.

### Division of Calibration Area

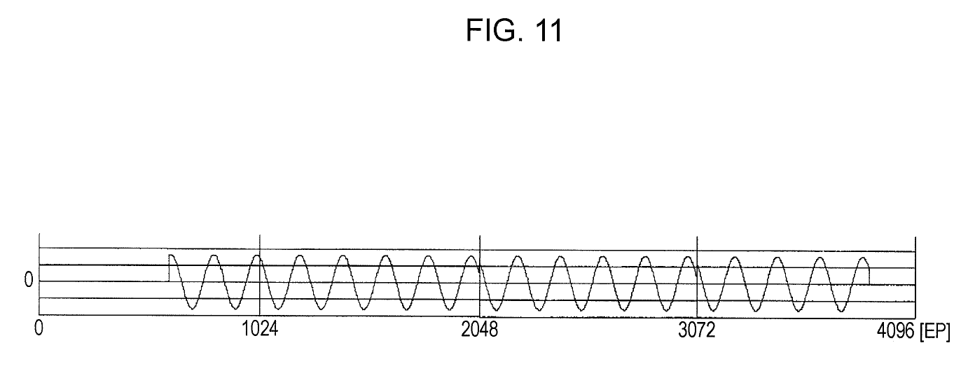

FIG. 11 is a schematic view for describing an example of a damper waveform, illustrating an example of the optimum phase for each of a plurality of areas dividing the movable range of the carriage 13. The illustrated damper waveform corresponds to a torque waveform having the opposite phase to that illustrated in FIG. 4. The vertical axis is in an arbitrary unit and represents only the magnitude of an amplitude. In a large-format printing apparatus, the reciprocating distance of the carriage 13 amounts to 24 inches or 44 inches, for example, and thus, the intensity or the phase of the cogging vibration may differ from position to position. To cope with this, as described above, parameters are registered in the NVRAM 55 for each of a plurality of areas dividing the movable range of the carriage 13, and the active damper 56 reads from the NVRAM 55, parameters corresponding to an area to which the position detected by the encoder position detection circuit 54 belongs and uses the parameters for controlling the driving state of the DC motor 21. In the example illustrated in FIG. 11, the movable range of the carriage 13 ranges from 0 to 4096 in terms of the pulse number of the linear encoder 25, and the ranges is divided into four areas. The amplitude (damper gain) and the phase offset of the damper waveform may be set to different values for each area, for each of the outward path and the homeward path, and for each speed mode.

### Optimum Parameter Detection Process

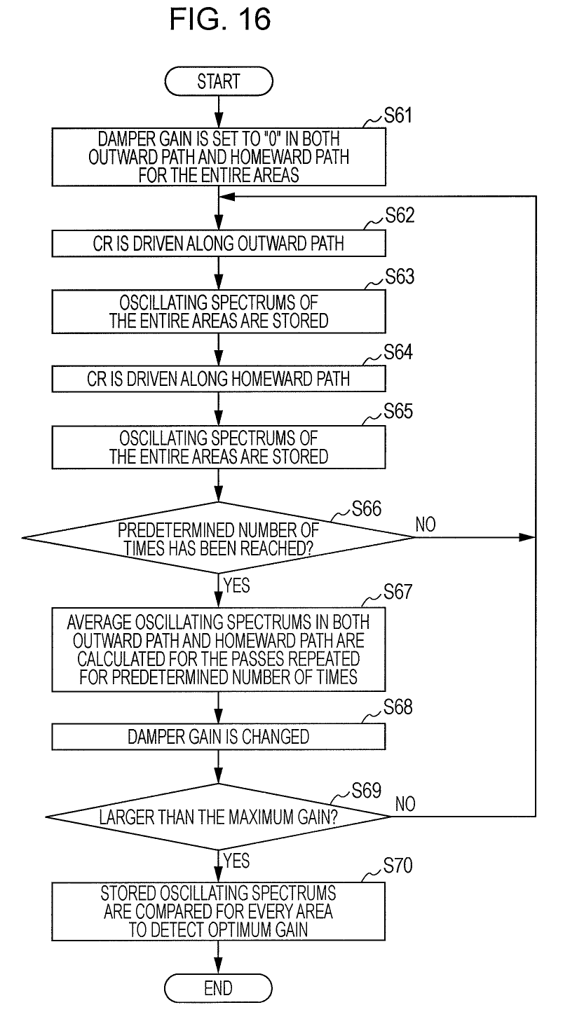

FIG. 12 is a flowchart of an optimum parameter detection process described as steps S22 and S26 in FIG. 10. First, the calibration execution control circuit 64 executes the optimum phase detection process (step S31; see FIG. 13) with a designated speed mode and obtains the optimum phase in each of the outward path and the homeward path for each area. Then, the optimum phases are set in the NVRAM 55 as the phases of the active damper 56 (step S32). Subsequently, the calibration execution control circuit 64 executes the optimum gain detection process (step S33; see FIG. 16) with the same speed mode and detects the optimum gain in each of the outward path and the homeward path for each area. The optimum gains are set in the NVRAM 55 as the gain of the active damper 56 (step S34). It should be noted that the operations of steps S31 and S32 may be executed later than the operations of steps S33 and S34, and the operations of steps S31 and S33 may be executed earlier than the operations of steps S32 and S34.

### Optimum Phase Detection Process

FIG. 13 is a flowchart illustrating the details of the optimum phase detection process described as step S31 in FIG. 12. First, the calibration execution control circuit 64 sets the gain of the active damper 56 to a value for detecting the optimum phase (step S41) and sets the phase of the active damper 56 to “0” in both the outward path and the homeward path for the entire areas (step S42). Subsequently, the calibration execution control circuit 64 causes the carriage 13 to be driven along the outward path (step S43) and stores the oscillating spectrums of the entire areas (step S44). Moreover, the calibration execution control circuit 64 causes the carriage 13 to be driven along the homeward path (step S45) and stores the oscillating spectrums of the entire areas (step S46). After the operations of steps S43 to S46 are repeated for a predetermined number of times (step S47), the calibration execution control circuit 64 calculates an average oscillating spectrum for the passes repeated for the predetermined number of times in each of the outward path and the homeward path (step S48). Then, the phase offset is changed (step S49), and the operations of steps S43 to S49 are repeated until all the values for the phase offsets are obtained (step S50). When all the values at different phase offsets are obtained, the calibration execution control circuit 64 compares the oscillating spectrums measured and stored for the phase offsets for every area to detect the optimum phase (step S51).

In this embodiment, the change amount of the phase offset is set to 16 in terms of a value when 360 degrees are expressed in 8 bits, namely 22.5 degrees. This value can be controlled with 8 bits and is the empirically optimum change amount. As a result, the oscillating spectrums (speed oscillating quantities) for 16 phases can be obtained.

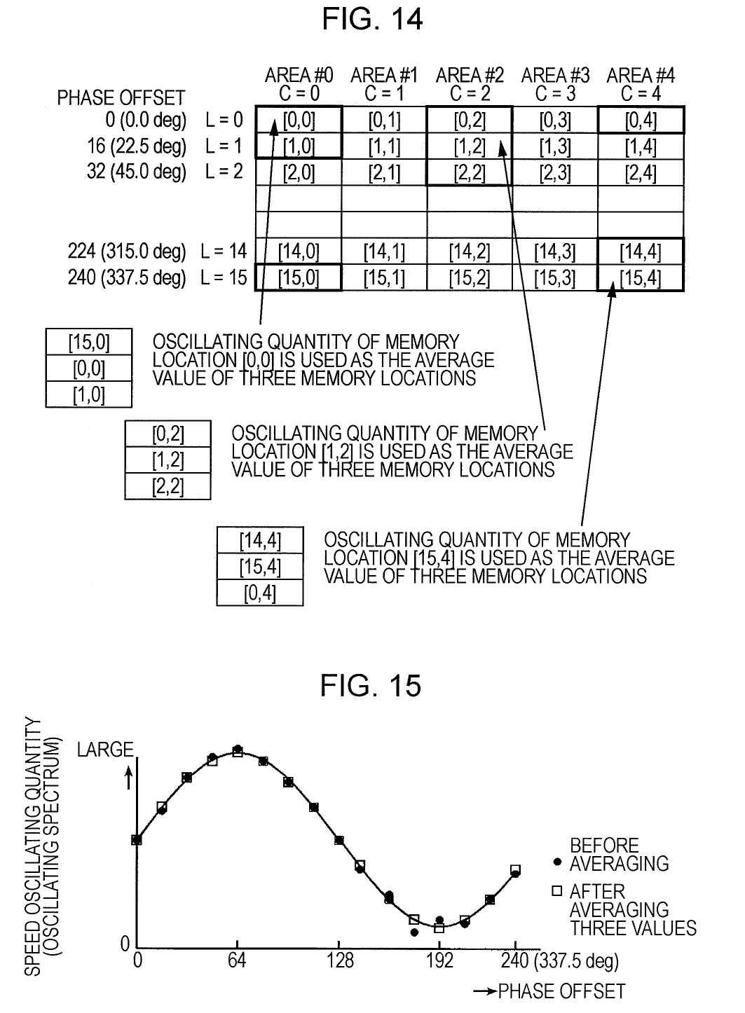

FIG. 14 is a schematic view for describing a smoothing process for detecting the optimum phase, illustrating the storage locations on a memory, of measured average oscillating spectrums. In FIG. 14, L and C represent the row and column numbers in a memory, respectively, and [L, C] is the storage location. The row number of the memory corresponds to the phase offset, and the column number corresponds to the area number. The calibration execution control circuit 64 stores the average oscillating spectrum calculated in step S48 of FIG. 13 in the horizontal memory locations in FIG. 14 as the speed oscillating quantity of each area. Moreover, the calibration execution control circuit 64 repeats the measurement by changing the phase offset, whereby the values are stored in the vertical memory locations in FIG. 14. In step S51 of FIG. 13, in order to smooth out the speed oscillating quantity to reject noise, the calibration execution control circuit 64 calculates the average value of three memory locations having neighboring phase offsets for an identical area as the value of the median memory location. That is to say, the average value of the respective values of three memory locations [L−1, C], [L, C], and [L+1, C] is used as the value of the memory location [L, C]. Here, the phase offsets of 0 and 240 (0 and 337.5 degrees) are also regarded neighboring, and accordingly, if L−1 is −1, then, it is regarded as (L−1)=15, and if L+1 is 16, then, it is regarded as (L+1)=0. Moreover, the speed oscillating quantities at respective phase offsets are compared for each area, the phase offset having the smallest oscillating quantity is used as the optimum value for that area. If a plurality of phase offsets is detected as having the smallest oscillating quantity, the smallest phase offset is used as the optimum value.

FIG. 15 is a graph illustrating the speed oscillating quantity in a certain area, for comparison between the speed oscillating quantity before averaging and the speed oscillating quantity obtained after averaging three values. In some cases, it cannot be said that the measurement errors are large in an area where the speed oscillating quantity is small and that a simple choice of the smallest speed oscillating quantity results in the optimum phase offset. The influence of such errors can be eliminated by averaging the speed oscillating quantities of neighboring phase offsets.

### Optimum Gain Detection Process

FIG. 16 is a flowchart illustrating the details of the optimum gain detection process described as step S33 in FIG. 12. First, the calibration execution control circuit 64 sets the damper gain to “0” in both the outward path and the homeward path for the entire areas (step S61). Subsequently, the calibration execution control circuit 64 causes the carriage 13 to be driven along the outward path (step S62) and stores the oscillating spectrums of the entire areas (step S63). Moreover, the calibration execution control circuit 64 causes the carriage 13 to be driven along the homeward path (step S64) and stores the oscillating spectrums of the entire areas (step S65). After the operations of steps S62 to S65 are repeated for a predetermined number of times (step S66), the calibration execution control circuit 64 calculates an average oscillating spectrum for the passes repeated for the predetermined number of times in each of the outward path and the homeward path (step S67). The calibration execution control circuit 64 changes the damper gain (step S68) and repeats the operations of steps S62 to S68 until the maximum gain is obtained (step S69). Then, the calibration execution control circuit 64 compares the stored oscillating spectrums for every area to detect the optimum phase (step S70).

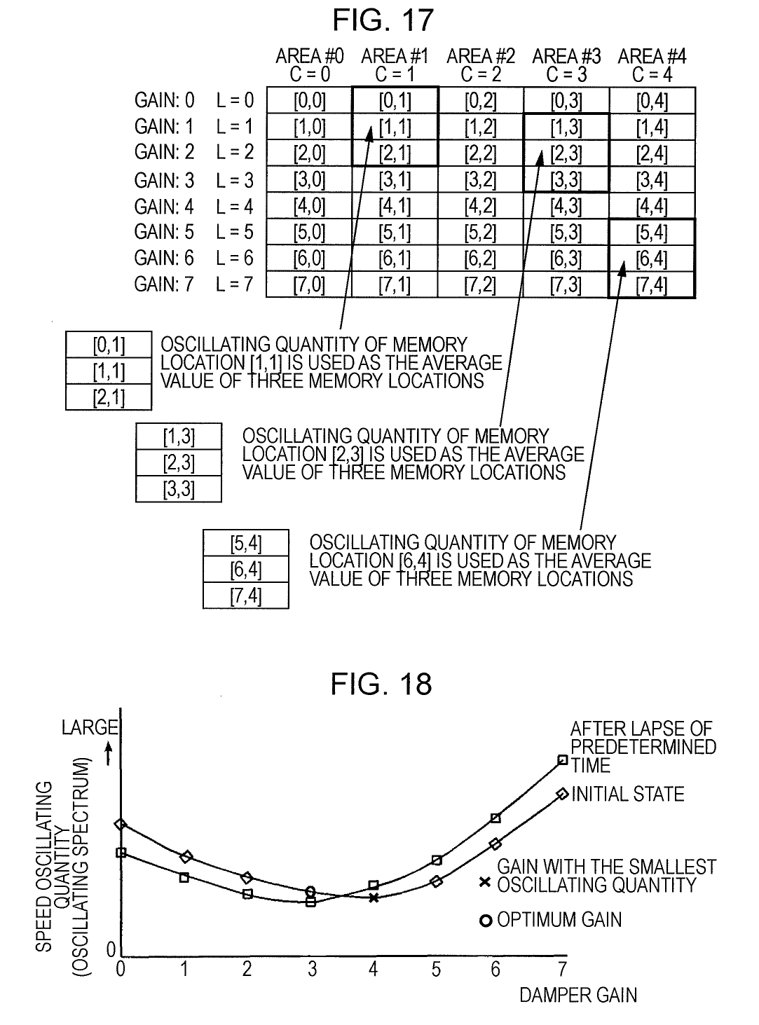

FIG. 17 is a schematic view for describing a smoothing process for detecting the optimum gain, illustrating the storage locations on a memory, of measured average oscillating spectrums. In FIG. 17, L and C represent the row and column numbers in a memory, respectively, and [L, C] is the storage location. The row number of the memory corresponds to the value (in arbitrary unit) of the damper gain, and the column number corresponds to the area number. In this example, the value of the damper gain is changed in 8 steps. The calibration execution control circuit 64 stores the average oscillating spectrum calculated in step S67 of FIG. 16 in the horizontal memory locations in FIG. 17 as the speed change amount of each area. Moreover, the calibration execution control circuit 64 repeats the measurement by changing the damper gain, whereby the values are stored in the vertical memory locations in FIG. 17. In step S70 of FIG. 16, in order to smooth out the speed oscillating quantity to reject noise, the calibration execution control circuit 64 calculates the average value of three memory locations having neighboring damper gains for an identical area as the value of the median memory location. That is to say, the average value of the respective values of three memory locations [L−1, C], [L, C], and [L+1, C] is used as the value of the memory location [L, C]. Here, unlike the case of the phase offset, the smallest gain and the largest gain are not neighboring, they are not averaged together. Moreover, the calibration execution control circuit 64 compares the speed oscillating quantities at respective gains for each area to obtain the damper gain having the smallest oscillating quantity. If a plurality of damper gains is detected as having the smallest oscillating quantity, the smallest damper gain is used as the optimum value.

FIG. 18 is a graph illustrating an example of the relationship between the initial oscillating spectrum after calibration and the oscillating spectrum after lapse of a predetermined period of time. A parameter which was optimum during calibration may adversely increase the oscillating quantity if the parameter varies over time. According to the measurement results, it can be concluded that the optimum gain detected by the optimum gain detection process shifts in the minus direction over time. Therefore, it is preferable to use a damper gain which is one step lower than the damper gain having the smallest oscillating quantity obtained in the optimum gain detection process as the optimum gain. Since the speed oscillating quantity exhibits a small change in the vicinity of the optimum gain, even when the one step lower damper gain is used as the optimum gain, the oscillation reduction effect will not be reduced much in the initial state. In addition, it is possible to prevent a reduction in the oscillation reduction effect even after lapse of time.

Moreover, if the vibration is damped with a torque larger than the excitation force thereof, the vibration will be accelerated adversely. Therefore, it is preferable that a gain capable of cancelling an oscillating quantity associated with the characteristics of the DC motor 21 is set as the upper limit of the maximum damper gain when detecting the optimum gain. For example, the upper limit gain is set as the cogging torque of the DC motor 21. Specifically, the sum of both side amplitudes is set to 40 g·cm (20 g·cm on single side). This upper limit value is smaller than “6” as an output gain value. This is calculated as follows. Since the maximum voltage of the DC motor is 42 V and one pitch of the active damper 56 amounts to 2,800 pulses (counts), the unit of gain is 0.015 V (=42 V÷2,800). Moreover, the resistance is 5Ω, so a calculation, 0.015÷5Ω=0.003 ampere, is obtained from the relationship of I=V/R. Moreover, the motor torque constant is 1,250 g·cm/ampere, so the torque becomes 3.75 g·cm (=0.003 ampere×1,250 g·cm/ampere). In this way, gain “1” amounts to 3.75 g·cm and gain “6” amounts to 22.5 g·cm.

### Oscillation Reduction Effect Detection Process

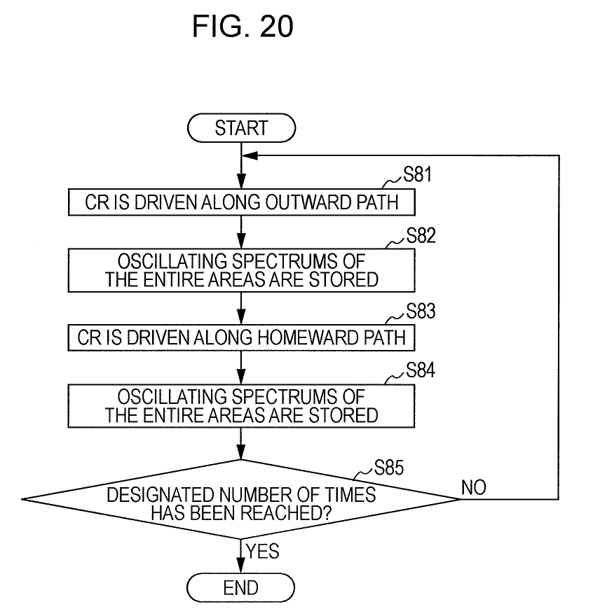

FIG. 19 is a flowchart illustrating the details of the oscillation reduction effect detection process described as steps S23 and S28 in FIG. 10. In this process, the calibration execution control circuit 64 performs a driving process of the carriage 13 in the designated speed mode for verification of the oscillation reduction effect (step S71; see FIG. 20 for detail) and measures and stores the oscillating spectrums for the entire areas over a plurality of times. Subsequently, the calibration execution control circuit 64 calculates the average value of the oscillating spectrums for the stored number of passes for every area and separately in both the outward path and the homeward path (step S72) and sets the average spectrum for each of the outward path and the homeward path as the reference oscillating quantity. Moreover, the calibration execution control circuit 64 sets the damper gain to “0” in both the outward path and the homeward path for the areas (step S74) and performs the same operation. That is to say, the calibration execution control circuit 64 performs the driving process of the carriage 13 for verification of the oscillation reduction effect to measure and store the oscillating spectrums for the entire areas over a plurality of times (step S75), calculates the average value of the oscillating spectrums for the stored number of passes for every area and separately in both the outward path and the homeward path (step S76), and sets the average spectrum for each of the outward path and the homeward path as the initial oscillating quantity (step S77).

FIG. 20 is a flowchart of a carriage driving process for verification of the effect of the calibration described as steps S71 and S75 in FIG. 19. The calibration execution control circuit 64 causes the carriage 13 to be driven along the outward path at the speed mode designated in step S23 or S28 of FIG. 10 (step S81) and stores the oscillating spectrums of the entire areas (step S82). Subsequently, the calibration execution control circuit 64 causes the carriage 13 to be driven along the homeward path at the same speed mode (step S83) and stores the oscillating spectrums of the entire areas (step S84). The above-mentioned operations are repeated for a designated number of times (step S85).

Although the exemplary embodiment of the printing apparatus of the invention has been described, it should be understood that various changes may be made therein without departing from the spirit or scope of the invention. For example, in the above-described embodiment, the speed oscillating quantity was measured for every area, and the determination on the optimality of the parameters was made by comparing the speed oscillating quantities of the identical area. However, when there are a small number of samples in one area, for example, the speed oscillating quantity may be measured and stored whenever the carriage 13 moves a predetermined width within one area.

In the above-described embodiment, although the average oscillating quantity is set to the reference oscillating quantity in steps S5 and S6 of the flow illustrated in FIG. 5, the relative threshold may be changed in accordance with the average oscillating quantity. Moreover, although the median value of three neighboring values of phases or gains is used as the average value when detecting the optimum phase or the optimum gain, the median value of five neighboring values rather than three values may be used as the average value. Alternatively, the measured speed oscillating quantity may not be averaged but used as it is; though, in such a case, there is a risk of occurrence of measurement errors.

Although in the description of FIG. 3, the NVRAM 55, the oscillating quantity measurement circuit 61, the average processing circuit 62, the determination circuit 63, and the calibration execution control circuit 64 were illustrated as separate configurations of the active damper 56, these configurations may be integrated into the active damper 56. Moreover, a part of the respective functions of these elements may be implemented in the control unit 31.

Furthermore, the main control unit 31, the transport driving circuit 35, the carriage drive circuit 36, and the print head controller 37 may be implemented by one microprocessor. The control program executed by the microprocessor may be stored in a built-in memory before shipment of the apparatus or may be stored in the built-in memory after the shipment. Moreover, a part of the control program may be stored or updated after shipment of the apparatus. When the apparatus has a communication capability, at least a part of the control program may be downloaded to be installed or updated.

Although the above description has been made for the case where the carriage of the printing apparatus is controlled to be driven in a reciprocating manner, if the printing is performed in only one direction, the active damping control, the determination on the oscillation reduction effect, and the calibration may be performed for only that direction. The invention is not limited to the printing apparatus but may be applied to any types of apparatuses that control the driving of a movable member. For example, the invention can be applied to the control of driving of a scanning unit of a copying machine or a scanner or an optical pickup unit of a CD (compact disk) or a DVD.

What is claimed is:

1. A movable member drive control device comprising:
a drive unit for driving a movable member;
a position detection unit for detecting the position of the movable member;
a drive control unit for controlling the driving of the drive unit in accordance with the position of the movable member, detected by the position detection unit; and
a determination unit for determining whether or not vibration of the movable member is reduced by the drive control unit.

2. The movable member drive control device according to claim 1, wherein the determination unit performs the determination as to whether or not the vibration of the movable member is reduced, on the condition that the movable member has passed through each of a plurality of areas dividing the movable range of the movable member.

3. The movable member drive control device according to claim 2, further comprising:
a parameter memory having registered therein parameters used by the drive control unit for controlling the driving of the drive unit; and
a parameter update unit for obtaining new parameters for cancelling the vibration of the movable member to update the contents of the parameter memory with the new parameters,
wherein the parameter update unit is configured to:
execute the updating at later possible timings, when it is determined that there is a risk of occurrence of failures in the driving of the movable member or a cause of occurrence of failures and the determination unit has determined that the vibration of the movable member is not reduced; and
execute the updating after the number of drivings of the movable member by the drive unit has exceeded a predetermined number of times, when the determination unit has determined that the vibration of the movable member is not reduced, under a state where there is neither the risk of occurrence of failures in the driving of the movable member nor the cause of occurrence of failures.

4. A movable member drive control method using a computer comprising:
a first step of measuring a vibration occurring in a movable member;
a second step of, when the movable member is driven, controlling the driving of the movable member in accordance with the position of the movable member based on the measurement results in the first step so that the vibration is cancelled out,
wherein a determination is made as to whether or not the vibration of the movable member is reduced by the control during the execution of the second step.
